(19) United States
(12) Patent Application Publication
(10) Pub. No.: US 2016/0300018 A1
(43) Pub. Date: Oct. 13, 2016

(54) A METHOD AND COMPUTER PROGRAM PRODUCT FOR MANAGEMENT OF THE DISTRIBUTION OF MEDICAL REPORTS IN CLINICAL APPLICATION

(71) Applicant: AGFA HEALTHCARE, B-Mortsel (BE)

(72) Inventors: Wannes KIECKENS, Mortsel (BE); Yong Li, Mortsel (BE); Justin You, Mortsel (BE)

(73) Assignee: Agfa HealthCare NV, Mortsel (BE)

(21) Appl. No.: 15/036,829

(22) PCT Filed: Nov. 27, 2014
(86) PCT No.: PCT/EP2014/075785

§ 371 Date: May 16, 2016

(30) Foreign Application Priority Data
Nov. 28, 2013 (EP) 13194924.0

(51) Int. Cl. G06F 19/00; H04L 29/06

(52) U.S. Cl. CPC G06F 19/322; H04L 63/10

(57) ABSTRACT

A method for the distribution of medical reports from a data processing system to one or more connected addressees and their distribution channels includes automatically determining the distribution channel and format as a function of an order and of configured distribution rules and format rules, converting the medical report to the correct distribution format, and automatically distributing the converted medical report to the distribution channel.

### CROSS-REFERENCE TO RELATED APPLICATIONS

This application is a 371 National Stage Application of PCT/EP2014/075785, filed Nov. 27, 2014. This application claims the benefit of European Application No. 13194924.0, filed Nov. 28, 2013, which is incorporated by reference herein in its entirety.

### BACKGROUND OF THE INVENTION

1. Field of the Invention

The present invention generally relates to management of the distribution of a medical report in clinical applications, e.g. in a medical imaging environment managing the distribution of the medical report to individual addressees or teams of individual addressees.

2. Description of the Related Art

Management of the distribution of medical reports is for instance important in medical applications such as radiology, where a technician acquires medical images of a patient, e.g. an x-ray scan, a CT scan, an MRI scan, an ultrasound scan, etc., a physician interprets the medical data, a medical secretary generates the medical report reflecting the physician's interpretation of the medical data, and the medical report is signed off by the physician. Finally, the medical secretary or the physician manually decides on the addressees of the medical report, i.e. who should receive the medical report, for instance the patient, an ordinary physician, the medical team of the patient's department, the medical team of the department to which the patient is transferred, etc. The medical secretary or the physician also manually chooses in which format the medical report is sent to the addressees, for example by e-mail, SMS, postal mail, printer, fax, etc. The medical report can for instance be printed out and the medical secretary then sends copies to postal addresses. The efficiency of the involved individuals is significantly lowered by this time-consuming manual procedure. Such manual distribution is also error prone as an addressee of the medical report can easily be forgotten.

US2010/0299157 describes a system for transferring medical records from one or more source locations to a destination location. The system includes a plurality of medical site clients that each have access to medical records at a corresponding medical site, and an exam distribution server connected to each of the plurality of medical site clients via a network. The exam distribution server is configured to receive manually inputted exam transfer requests that specifies both criteria to determine whether exams should be transferred and the addressee to which medical exams meeting specified criteria should be transferred. The addressee can be notified via e-mail, SMS, pager that the medical report is available on the exam distribution server. Subsequently, if permissions exist for the addressee to connect to the exam distribution server, the addressee must access the exam distribution server with a specific identification and retrieve the medical report itself. In this system, an addressee is identical to a distribution channel, i.e. the destination of the medical report. The medical report must be addressed to distribution channels that vary from one type of patient to another. For instance, the medical report of an in-patient, this means a patient treated and staying in the same specific medical department, must be printed to be available in the patient's current department. The medical report of an out-patient, i.e. a patient treated in a specific medical department, but transferred to another medical department or released, must be sent to an ordinary physician that has no permission to access the exam distribution server of the medical department, and a notification should be sent to the patient himself via a preferred distribution format, for example e-mail, SMS, pager, etc. The manual management of the distribution of medical reports presented in this system is not flexible on the selection of distribution channels and their preferred distribution formats. Also, it is only valid if all the distribution channels are connected to the exam distribution server.

Another limitation of a manual procedure is that the medical department is unable to quickly adapt its delivering strategy of medical reports in case of change in the workflow of the acquisition of the medical data. After a certain period of time, the medical department may for example need to address the medical report to the patient's insurance company. This requires the connection of an extra addressee to the exam distribution server, and the intervention of a specialized operator in information technology to set the communication up.

### SUMMARY OF THE INVENTION

It is an objective of the present invention to disclose a computer-implemented method and tool that overcome the above identified shortcomings of existing tools. More particularly, it is an objective to disclose such a method and tool for use in clinical applications that reduces the need for manual intervention in the distribution of a medical report.

According a first aspect of the present invention, the above defined objectives are realized by a method for operating a data processing system for distribution of a medical report to one or more connected addressees and corresponding distribution channels, said method comprising:

receiving an order specifying a type of medical study;

configuring programmable distribution rules in said system which associate addressees and corresponding distribution channels with types of medical study;

configuring programmable format rules in said system which associate distribution formats with addressees and corresponding distribution channels;

receiving said medical report associated with said order;

automatically determining for said order the corresponding distribution channel and the corresponding distribution format in function of said order, said distribution rules and said format rules;

converting said medical report to said corresponding distribution format for said corresponding distribution channel, thereby generating a converted medical report; and

automatically distributing said converted medical report to said corresponding distribution channel.

A preferred embodiment of the invention includes receiving an order that specifies the type of medical study that needs to be conducted on the patient. For each possible medical study, rules are initially configured in the system and associate addressees of the medical report generated after examination of the patient with the corresponding distribution channels and to their preferred distribution formats. Based on the received order and the pre-configured rules, a method according to the invention then determines which distribution channel will receive the medical report and in which format. The medical report is converted to the corresponding distribution format. Thanks to the database of configurable rules, the medical report is automatically sent to the corresponding distribution channel in the corresponding distribution format with minimal waste of time and human intervention. This way, the effort and efficiency of the medical team is no longer wasted by a time-consuming manual procedure. The above also improves the flexibility and the simplicity of the communication over medical reports of patients. The above description concerns one specific distribution channel and/or its corresponding distribution format, but it is understood that the same principle will be applied if more distribution channels and several distribution formats are involved.

According to an optional preferred embodiment of the invention, a method according to the present invention may further comprise:

further configuring distribution rules and format rules in function of an addressee property.

According to an optional preferred embodiment of the invention, a method according to the present invention may further configure distribution rules and format rules in function of an addressee property, wherein the addressee property is a patient type. This could for example be implemented by means of a Domain Specific Language or DSL, which allows for a user-friendly input of the distribution rules and format rules, without requiring the intervention of a specialist in information technology.

According to an optional preferred embodiment of the invention, a method according to the present invention may further comprise distribution rules and format rules in function of a patient type wherein the patient type comprises at least one of the following:

an in-patient type, which indicates it is a patient residing inside the medical department;

an out-patient type, which indicates it is a patient not residing inside the medical department.

According to an optional preferred embodiment of the invention, a method according to the present invention may further comprise distribution rules and format rules in function of a patient type wherein the corresponding distribution rule for the in-patient type comprises at least delivery to the medical department of a print.

This way, the communication between the medical team and the addressees is made flexible and facilitated thanks to the distinction between different types of patients.

According to another optional preferred embodiment, a method for operating a data processing system according to the present invention further comprises the step of automatically determining for the order the corresponding addressees in function of the distribution rules.

This way, the efficiency of the medical team is further improved.

Also, optionally, a method for operating a data processing system according to the present invention further comprises:

verifying if the programmable format rules are configured for the corresponding distribution channel selected according to the received order and the received medical report, before automatically determining the distribution format for the received order.

This way, the data processing system automatically checks if distribution rules and format rules exist in the system for each addressee, depending on the received order and on the medical report of the patient. The method is thus less prone to errors.

According to another optional preferred embodiment, a method for operating a data processing system according to the present invention further comprises:

if said verification determines that no programmable format rules are configured, then an additional programmable format rule is added to the system to specify a corresponding distribution format for the corresponding distribution channel, after reception of the medical report associated with the order.

Hence, distribution rules and format rules can be inputted to the system to be associated to an addressee, to specify the corresponding distribution channel and the preferred distribution format. This brings flexibility to the automatic distribution procedure.

Optionally, a method according to the present invention further comprises:

verifying if the order specifies additional necessary medical study.

This way, the medical report will only be sent to the addressees and the corresponding distribution channels when the medical examination is complete and when the medical team has inputted conclusions to the medical report.

Optionally, a method according to the present invention further comprises:

adding additional images to the medical report, if the verification specified additional medical study is necessary.

This way, the medical report can be updated with new medical images and conclusions from the medical team.

According to another optional preferred embodiment, a method for operating a data processing system according to the present invention further comprises an automatic reception of a medical report from a medical image acquisition device.

This way, the medical report can be automatically inputted in the data processing system from a medical image acquisition device.

According to a second aspect of the invention, there is a data processing system distributing a medical report to one or more connected addressees and to the corresponding distribution channels, by means of a method according to the first aspect of the invention, characterized in that the system comprises:

an order interface configured to receive an order specifying a type of medical study;

a database comprising programmable distribution rules in the system which are configured to associate addressees and corresponding distribution channels with types of medical study;

a database comprising programmable format rules in the system which are configured to associate distribution formats with addressees and corresponding distribution channels;

a report interface to receive the medical report associated with the order;

an association module configured to automatically determine for the order the corresponding distribution channel and the corresponding distribution format in function of the order, the distribution rules and the format rules;

a conversion module configured to convert the medical report to the corresponding distribution format for the corresponding distribution channel, thereby generating a converted medical report; and

a distribution module configured to automatically distribute the converted medical report to the corresponding distribution channel.

Preferred embodiments of the current invention in addition also relate to a computer program comprising software code adapted to perform the method.

Preferred embodiments of the invention further relate to a computer readable storage medium comprising the computer program.

### BRIEF DESCRIPTION OF THE DRAWINGS

FIG. 1 schematically illustrates a preferred embodiment of the data processing system for distribution of medical reports, for a first type of patient.

FIG. 2 schematically illustrates the preferred embodiment of FIG. 1, for a second type of patient.

FIG. 3 is a flow chart of an alternative preferred embodiment of a method according to the present invention.

FIG. 4 schematically illustrates a preferred embodiment of a programmable distribution rule configured in the data processing system.

FIG. 5 schematically illustrates a suitable computing system for hosting the data processing system of FIG. 1.

### DETAILED DESCRIPTION OF THE PREFERRED EMBODIMENTS

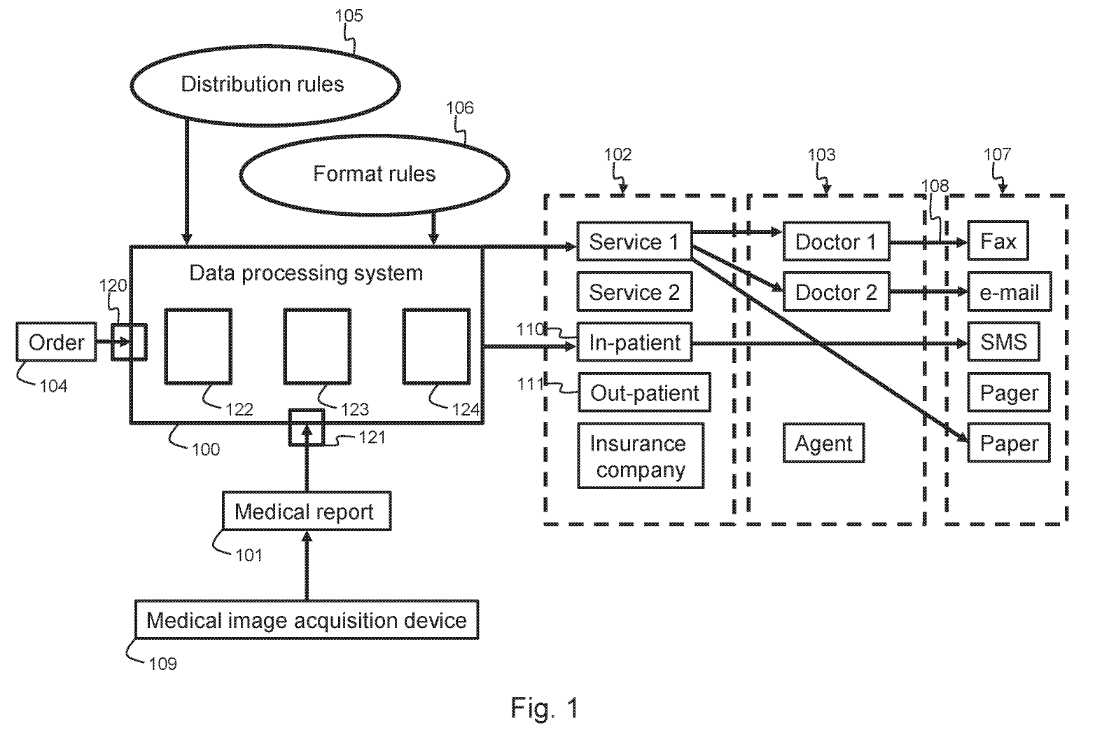

FIG. 1 schematically illustrates a basic implementation of a preferred method according to the invention. Such method is implemented for operating a data processing system 100 that distributes medical reports 101 in clinical applications. This is for example the case in the context of the medical examination of a patient in a medical imaging environment, such as a radiology department. An order 104 specifying a type of medical study is inputted in the data processing system 100 by the medical team through an order interface 120 that may comprise a graphical user interface suited for manual input of the order 104. A type of medical study specified by the order 104 relates to the type of medical examination that needs to be carried out on a patient, i.e. which medical images of a patient need to be acquired and stored on the data processing system 100, e.g. an x-ray scan, a CT scan, an MRI scan, an ultrasound scan, etc., performed by a suitable medical image acquisition device 109. After acquisition of the medical images of the patient by a technician, a physician interprets the medical images, a medical secretary generates the medical report 101 reflecting the physician's interpretation of the medical data and the medical images acquired by the technician, and finally the medical report 101 is signed off by the physician. The medical report 101 is inputted by the medical team through a report interface 121 in the data processing system 100. The report interface 121 may comprise a graphical user interface suited for manual input of the medical report 101. Alternatively, as shown in FIG. 1, the medical report can be automatically received from a medical image acquisition device 109 through a suitable network interface. The medical report 101 is further stored in the data processing system 100. The individuals involved in the generation of the medical report 101 may be working in a single facility, e.g. the same medical department of a hospital or imaging centre, or may be working at different locations, e.g. different medical departments of a hospital or company with multiple facilities. The medical team of the department where the patient is examined chooses the addressees 102 who should receive the medical report 101. Each addressee 102 has a functional role related to the medical report 101, e.g. the medical department where the patient is examined, the medical department to which the patient is transferred, the patient, the insurance company of the patient, etc. To some addressees 102 correspond distribution channels 103 that specify contact information of the representative of the functional role of the addressee 102. This can be for instance the name of the specific doctor within the medical department that examined the patient, the name and pager number of a specific doctor within another medical department, the name and e-mail address of an agent of the insurance company of the patient, the name and telephone number of an ordinary physician, etc.

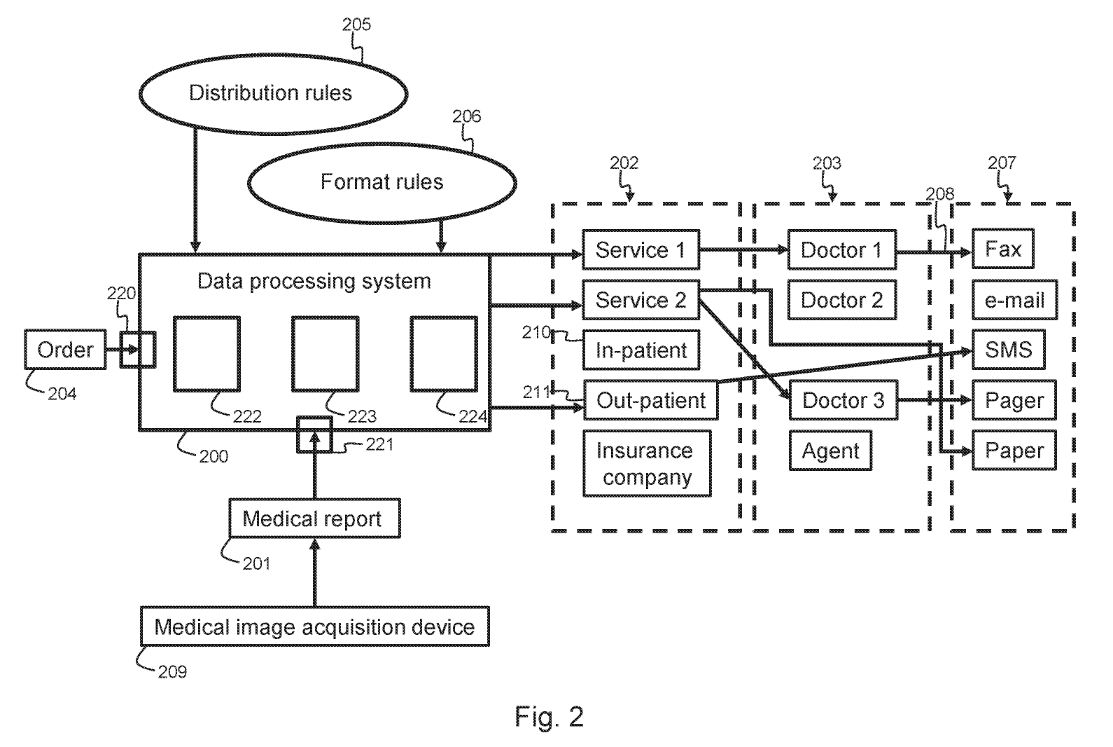

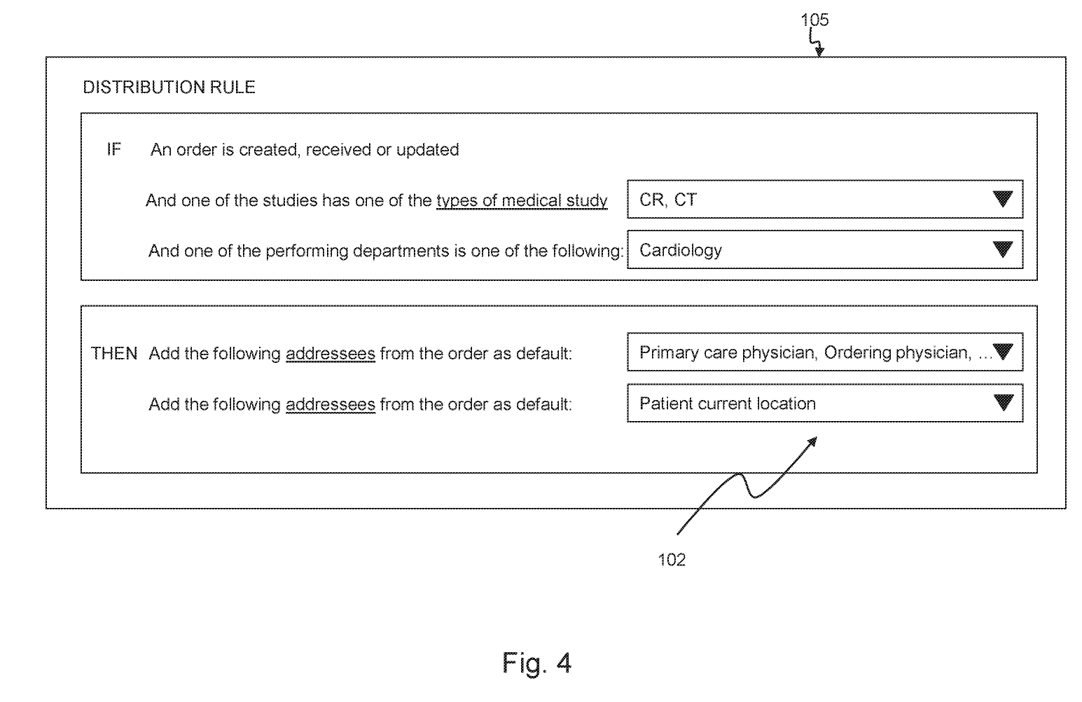

The data processing system 100 comprises a database of programmable distribution rules 105. The programmable distribution rules 105 associate specific types of medical study with certain addressees 102 and their corresponding distribution channels 103. This means that for each type of medical study carried out on a patient, the programmable distribution rules 105 are configured to select, depending on the order 104 and the medical report 101, the addressees 102 and the corresponding distribution channels 103 receiving the medical report 101, and to communicate them to the data processing system 100. The distribution rules 105 are preferably configured in Domain Specific Language, or DSL, which is a computer language specialized to a particular application domain, for instance as visible on the print-screen depicted in FIG. 4 where the medical department and the type of medical study of the medical report 101 are associated with addressees 102 which can be manually selected from drop-down menus. This way, the configuration or the modification of programmable rules in the data processing system 100 do not require the intervention of an information technology specialist, but can be performed by the medical team of the medical department. It is clear that according to this preferred embodiment the addressees 102 can be automatically determined by means of the distribution rules 105 in function of the type of the medical study as defined in the order 104. When the medical report 101 is inputted in the data processing system 100, it is related to an already defined order 104 in the data processing system 100. The data processing system 100 then automatically determines for this order 104 the corresponding distribution channels 103 and the corresponding distribution formats 107 in function of the order 104 and the distribution rules 105 and the format rules 106. This means that the addressees 102 and the distribution channels 103 of the medical report 101 are automatically selected by an association module 122 of the data processing system 100 thanks to the database of distribution rules 105 and format rules 106, depending of the medical report 101 and on the order 104 received by the data processing system 100. For instance, in the situation depicted in FIG. 1, an order 104 is configured in the data processing system 100 for a type of medical study, which can be for example acquiring an x-ray scan of the patient. The x-ray scan is then acquired by a technician and the conclusions of the physician are added to the medical report 101. The medical report is manually inputted in the data processing system 100. For the received order 104, distribution rules 105 are configured to deliver the medical report 101 to addressees 102 that are the medical department in which the patient is examined and the patient himself. Distribution rules 105 also specify the corresponding distribution channels 103, who are for this order 104 the physician who has examined the patient and another physician from the same medical department. In the situation depicted in FIG. 2, an order 204 is configured in the data processing system 200 for a type of medical study, which can be for example acquiring a CT scan of the patient. The CT scan is then acquired by a technician and the conclusions of the physician are added to the medical report 201. The conclusions state that extra medical study in another medical department is required. The medical report 201 is manually inputted in the data processing system 200. For the received order 204, distribution rules 205 are configured to deliver the medical report 201 to addressees 202 that are the medical department in which the patient is examined, the medical department to which the patient must be transferred, and the patient himself. Distribution rules 205 also specify the corresponding distribution channels 203, who are for this order 204 the physician who has examined the patient and the physician who is going to examine the patient in the medical department to which the patient is transferred.

The data processing system 100 further comprises a database of programmable format rules 106. The programmable format rules 106 associate the distribution channels 103 receiving the medical report 101 with a specific corresponding distribution format 107. This means that for each type of medical study carried out on a patient, the programmable format rules 106 are configured to communicate the preferred distribution format 107 of each distribution channel 103 to the data processing system 100. The format rules 106 are preferably configured in Domain Specific Language, or DSL, which is a computer language specialized to a particular application domain, for instance similar as shown for the distribution rules in FIG. 4. This way, the configuration or the modification of programmable format rules 106 in the data processing system 100 do not require the intervention of an information technology specialist, but can be performed by the medical team of the medical department. When the medical report 101 is inputted in the data processing system 100, it is related to an already defined order 104 in the data processing system 100. The data processing system 100 then also automatically determines for this order 104 the corresponding distribution formats 107 for each distribution channel 103 in function of the order 104 and the distribution rules 105 and the format rules 106.

This means that the distribution formats 107 of the medical report 101 are automatically selected by an association module 122 of the data processing system 100 thanks to the database of distribution rules 105 and format rules 106, depending on the medical report 101 and on the order 104 received by the data processing system 100. The medical report 101 is then converted to the corresponding distribution format 107 associated with the selected distribution channels 103. The conversion is done by a conversion module 123 of the data processing system 100. The medical report 100 may be converted to any preferred format of the distribution channels 103, such as e-mail, fax, SMS, etc. Finally, the converted medical report 108 is automatically distributed to the distribution channels 103 by a distribution module 124 of the data processing system 100. These preferred distribution formats for each distribution channel 103 are programmed in the format rules 106. For instance, in the situation depicted in FIG. 1, a distribution channel 103 is a doctor from the medical department where the patient is examined. The doctor prefers receiving the medical report 101 in the preferred distribution format 107 which is by fax, while another distribution channel is a doctor from the same medical department, who prefers receiving the medical report 101 in the distribution format 107 that is by e-mail. Another addressee 102 of the medical report 101 is the medical department itself, and the preferred corresponding distribution format 107 is a print of the medical report 101. For instance, in the situation depicted in FIG. 2, a doctor from the medical department where the patient is examined prefers receiving the medical report 201 by fax, while another doctor from a different medical department prefers receiving the medical report 201 by pager. Another addressee 202 of the medical report 201 is the medical department itself, and the preferred corresponding distribution format 207 is a print of the medical report 201.

According to a preferred embodiment shown in FIG. 1-2, the method for operating a data processing system 100, 200 comprises the possibility to further configure distribution rules 105, 205 and format rules 106, 206 according to a specific property of an addressee 102, 202. The property of an addressee 102, 202 is the type of the patient related to the medical report 101, 201. If the medical report 101, 201 concludes that the patient is an in-patient 110, 210, i.e. a patient staying in the medical department, the medical report 101, 201 must be printed for consultation in the medical department, and can be converted and the converted medical report 108, 208 is automatically distributed to the addressees 102, 202 and the corresponding distribution channels 103, 203 in their preferred distribution format 107, 207. In the situation depicted in FIG. 1 for instance, the medical report 101 of an in-patient 110 will be printed for consultation within the medical department, and will be distributed to a first doctor by fax and to a second doctor from the same medical department by e-mail, while the patient himself is alerted by SMS. However, if the medical report 101, 201 concludes that the patient is an out-patient 111, 211, i.e. a patient transferred to another medical department or released, the medical report 101, 201 will be automatically distributed to the addressees 102, 202 as defined in the distribution rules 105, 205 and the corresponding distribution channels 103, 203 in their preferred distribution format 107, 207 as defined in the format rules 106, 206. In the situation depicted in FIG. 2 for instance, the medical report 201 of an out-patient 211 is automatically distributed to a first doctor from the medical department by fax and to a second doctor from another medical department by pager, while the patient himself is alerted by SMS.

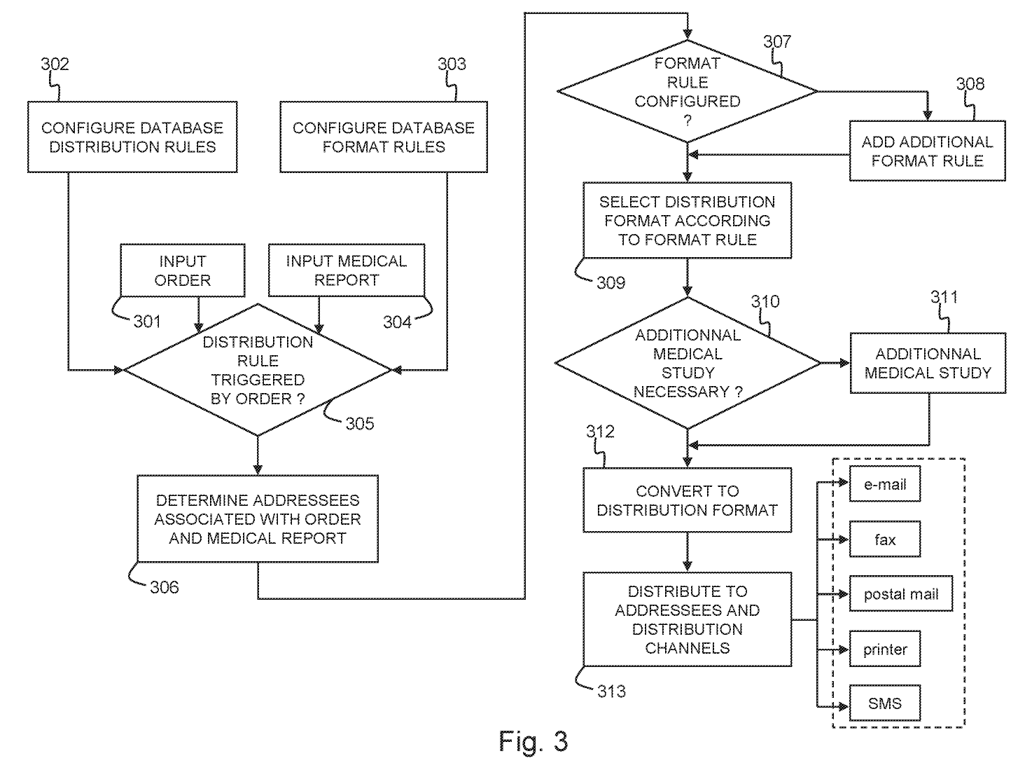

FIG. 3 illustrates an alternative preferred embodiment of the method according to the invention. In step 301, the medical team configures in the data processing system 100, 200 an order comprising a type of medical study. The order 104, 204 is inputted in the system through an order interface 120, 220 that may comprise a graphical user interface suited for manual input of the order. In step 302, programmable distribution rules 105, 205 are configured in the data processing system. The programmable distribution rules 105, 205 specify who the addressees 102, 202 of the medical report 101, 201 and the corresponding distribution channels 103, 203 are, i.e. who will receive the medical report 101, 201. In step 303, programmable format rules 106, 206 are configured in the data processing system 100, 200. The programmable format rules 106, 206 specify which distribution format 107, 207 is preferred by each distribution channel 103, 203. This way, the distribution method of the medical report 100, 200 is flexible and the medical report 101, 201 itself is made accessible to all the involved distribution channels 103, 203 without waste of time or extra effort needed from the medical team of the medical department. In step 304, the medical report 101, 201 is inputted in the data processing system 100, 200 through a report interface 121, 221 that may comprise a graphical user interface suited for manual input of the medical report 101, 201. Alternatively, the medical report 101, 201 can be automatically received from a medical image acquisition device 109, 209 through a suitable network interface. The medical report 101, 201 reflects a physician's interpretation of the medical data and the medical images acquired by a technician. In step 305, the data processing system 100, 200 checks if distribution rules 105, 205 are related to the order 104, 204 and the medical report 101, 201. In step 306, an association module 122, 222 determines which addressees 102, 202 are selected to receive the medical report 101, 201 based on the order 104, 204, the programmable distribution rules 105, 205 and the medical report 101, 201. In step 307, the data processing system 100, 200 checks if a programmable format rule 106, 206 is configured for each of the selected distribution channel 103, 203. If no programmable format rule 106, 206 is stated for a distribution channel 103, 203, the medical team can add in step 308 an additional programmable format rule 106, 206 to specify a corresponding distribution format 107, 207 to the corresponding distribution channel 103, 203. In step 309, depending on the order 104, 204 and the programmable format rules 106, 206, the data processing system 100, 200 determines the distribution format 107, 207 of the medical report 101, 201 for each corresponding distribution channel 103, 203. In step 310, the data processing system 100, 200 checks if additional medical studies are necessary to perform on the patient. If so, additional medical studies are performed on the patient in step 311. This way, the medical report 101, 201 of the patient is updated with additional medical images and physician's interpretation of the medical images. In step 312, a converting module 123, 223 from the data processing system 100, 200 converts the medical report 101, 201 to the distribution formats 107, 207 determined by the programmable format rules 106, 206 as a function of the distribution channels 103, 203. A converted medical report 108, 208 is then generated in step 312. Finally, the converted medical report 108, 208 is automatically distributed by a distributing module 124, 224 of the data processing system 100, 200 to the involved addressees 102, 202 and corresponding distribution channels 103, 203 in the preferred format 107, 207 specified by the distribution format rules 106, 206. This way, human intervention for the distribution of medical reports 101, 201 is minimized, and the medical reports are automatically distributed.

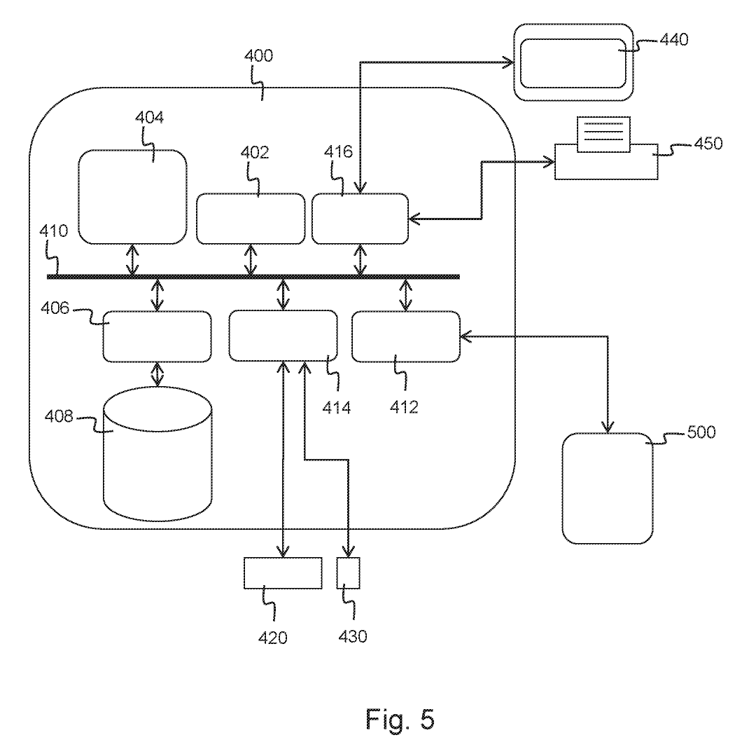

FIG. 5 shows a suitable computing system 400 for hosting the data processing system 100; 200 of FIG. 1 or 2. Computing system 400 may in general be formed as a suitable general purpose computer and comprise a bus 410, a processor 402, a local memory 404, one or more optional input interfaces 414, one or more optional output interfaces 416, a communication interface 412, a storage element interface 406 and one or more storage elements 408. Bus 410 may comprise one or more conductors that permit communication among the components of the computing system. Processor 402 may include any type of conventional processor or microprocessor that interprets and executes programming instructions. Local memory 404 may include a random access memory (RAM) or another type of dynamic storage device that stores information and instructions for execution by processor 402 and/or a read only memory (ROM) or another type of static storage device that stores static information and instructions for use by processor 404. Input interface 414 may comprise one or more conventional mechanisms that permit an operator to input information to the computing device 400, such as a keyboard 420, a mouse 430, a pen, voice recognition and/or biometric mechanisms, etc. Output interface 416 may comprise one or more conventional mechanisms that output information to the operator, such as a display 440, a printer 450, a speaker, etc. Communication interface 412 may comprise any transceiver-like mechanism such as for example two 1 Gb Ethernet interfaces that enables computing system 400 to communicate with other devices and/or systems, for example mechanisms for communicating with one or more other computing systems 500. The communication interface 412 of computing system 400 may be connected to such another computing system by means of a local area network (LAN) or a wide area network (WAN, such as for example the internet, in which case the other computing system 500 may for example comprise a suitable web server. Storage element interface 406 may comprise a storage interface such as for example a Serial Advanced Technology Attachment (SATA) interface or a Small Computer System Interface (SCSI) for connecting bus 410 to one or more storage elements 408, such as one or more local disks, for example 1TB SATA disk drives, and control the reading and writing of data to and/or from these storage elements 408. Although the storage elements 408 above is described as a local disk, in general any other suitable computer-readable media such as a removable magnetic disk, optical storage media such as a CD or DVD, -ROM disk, solid state drives, flash memory cards, . . . could be used.

The data processing system 100; 200 can be implemented as programming instructions stored it local memory 404 of the computing system 400 for execution by its processor 402. Alternatively the data processing system 100; 200 could be stored on the storage element 408 or be accessible from another computing system 500 through the communication interface 412.

Although the present invention has been illustrated by reference to specific preferred embodiments, it will be apparent to those skilled in the art that the invention is not limited to the details of the foregoing illustrative preferred embodiments, and that the present invention may be embodied with various changes and modifications without departing from the scope thereof. The present preferred embodiments are therefore to be considered in all respects as illustrative and not restrictive, the scope of the invention being indicated by the appended claims rather than by the foregoing description, and all changes which come within the meaning and range of equivalency of the claims are therefore intended to be embraced therein. In other words, it is contemplated to cover any and all modifications, variations or equivalents that fall within the scope of the basic underlying principles and whose essential attributes are claimed in this patent application. It will furthermore be understood by the reader of this patent application that the words “comprising” or “comprise” do not exclude other elements or steps, that the words “a” or “an” do not exclude a plurality, and that a single element, such as a computer system, a processor, or another integrated unit may fulfil the functions of several means recited in the claims. Any reference signs in the claims shall not be construed as limiting the respective claims concerned. The terms “first”, “second”, third”, “a”, “b”, “c”, and the like, when used in the description or in the claims are introduced to distinguish between similar elements or steps and are not necessarily describing a sequential or chronological order. Similarly, the terms “top”, “bottom”, “over”, “under”, and the like are introduced for descriptive purposes and not necessarily to denote relative positions. It is to be understood that the terms so used are interchangeable under appropriate circumstances and preferred embodiments of the invention are capable of operating according to the present invention in other sequences, or in orientations different from the one(s) described or illustrated above.

1-10. (canceled)

11. A method for operating a data processing system for distributing a medical report to one or more addressees and corresponding distribution channels, the method comprising the steps of:
receiving an order specifying a type of medical study;
configuring programmable distribution rules to associate the one or more addressees and the corresponding distribution channels with the type of medical study;
configuring programmable format rules to associate a distribution format with the one or more addressees and the corresponding distribution channels;
receiving the medical report associated with the order;
automatically determining for the order the corresponding distribution channel and the associated distribution format as a function of the order, the programmable distribution rules, and the programmable format rules;
converting the medical report to the associated distribution format for the corresponding distribution channel to generate a converted medical report; and
automatically distributing the converted medical report to the corresponding distribution channel.

12. The method for operating a data processing system according to claim 11, further comprising the step of:
further configuring the programmable distribution rules and the programmable format rules as a function of a property of the one or more addressees.

13. The method for operating a data processing system according to claim 12, wherein a programmable distribution rule of the programmable distribution rules for an in-patient includes at least delivery of a print of the medical report to a medical department.

14. The method for operating a data processing system according to claim 11, further comprising the step of:
automatically determining for the order the one or more addressees as a function of the programmable distribution rules.

15. The method for operating a data processing system according to claim 11, further comprising the step of:
verifying if the programmable format rules are configured for the corresponding distribution channel selected according to the order and the medical report, before automatically determining the associated distribution format for the order.

16. The method for operating a data processing system according to claim 15, further comprising the step of:
if the step of verifying determines that no programmable format rules are configured, then adding to the data processing system an additional programmable format rule to specify a corresponding distribution format for the corresponding distribution channel, after receiving the medical report associated with the order.

17. The method for operating a data processing system according to claim 11, further comprising the step of:
verifying if the order specifies additional necessary medical study.

18. A data processing system for distribution of a medical report to one or more addressees and corresponding distribution channels, the data processing system comprising:
an order interface that receives an order specifying a type of medical study;
a database including programmable distribution rules that associate the one or more addressees and the corresponding distribution channels with the type of medical study;
a database including programmable format rules that associate a distribution format with the one or more addressees and the corresponding distribution channels;
a report interface that receives the medical report associated with the order;
an association module that automatically determines for the order the corresponding distribution channel and the associated distribution format as a function of the order, the programmable distribution rules, and the programmable format rules;
a conversion module that converts the medical report to the associated distribution format for the corresponding distribution channel to generate a converted medical report; and
a distribution module that automatically distributes the converted medical report to the corresponding distribution channel.

19. A non-transitory computer readable storage medium comprising computer-executable instructions which, when executed by a computing system, perform the method according to claim 11.
